(19) United States
(12) Patent Application Publication
(10) Pub. No.: US 2007/0068164 A1
(43) Pub. Date: Mar. 29, 2007

(54) ANTI-COKING INJECTOR ARM

(75) Inventors: Didier Hernandez, Quiers (FR); Thomas Olivier Marie Noel, Paris (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA, Paris (FR)

(21) Appl. No.: 11/535,667

(22) Filed: Sep. 27, 2006

(30) Foreign Application Priority Data
Sep. 28, 2005 (FR) 0509879

(51) Int. Cl. F02C 7/22

(52) U.S. Cl. 60/740

(57) ABSTRACT

According to the invention, the injector arms comprise a peripheral duct forming part of a primary fuel circuit that delivers fuel continuously, and a central duct forming part of a secondary fuel circuit that delivers fuel at an essentially variable rate.

The invention relates to a fuel injector fitted to the combustion chamber of a gas turbine engine, more particularly an airplane turbojet. The invention relates in particular to an improvement for avoiding fuel coking in the injector arm in which there are provided two ducts that are coaxial and that belong to two different fuel feed circuits, respectively a primary circuit and a secondary circuit.

### BACKGROUND OF THE INVENTION

In an airplane turbojet, the combustion chamber is provided with a plurality of injectors that are regularly distributed circumferentially in the end wall of the annular combustion chamber. Each injector comprises a curved arm terminated by a spray head. The arm is secured to the outer casing surrounding the combustion chamber, and the fuel flows along the arm to the spray head. Compressed air coming from a high-pressure compressor flows inside the casing. The fuel is mixed with the air in the end of the combustion chamber before igniting therein.

In order to guarantee that the fuel is sprayed properly under all operating conditions of the engine, mechanical injectors have been proposed having two fuel circuits referred to respectively as the primary circuit and the secondary circuit.

The so-called “primary” circuit or idling circuit is designed to obtain a particularly fine spray of fuel. Its delivery rate is small but continuous.

The so-called “secondary” circuit or full-throttle circuit is designed to increase the fuel delivery rate up to the full throttle point that makes it possible, in particular, to deliver all the power required for takeoff. However, the secondary circuit is not used continuously and its delivery rate is sometimes very low at certain speeds.

The fuel from these two circuits reaches the spray head by flowing along coaxial ducts defined inside the arm.

Conventionally, the central duct belongs to the primary circuit and the tubular duct surrounding it belongs to the secondary circuit. However, the major portion of the injector, and in particular the arm, can be subjected to high temperatures (300 K to 950 K for full throttle operation) since such an arm extends in a flow of hot air coming from the last stage of the high-pressure compressor. In addition, during certain stages of operation in which the temperature of the air coming from the compressor is relatively high (430 K to 600 K), the secondary circuit need not be in use or may be delivering at a very low rate, as mentioned above.

This can result in clogging or coking of the fuel that is stagnating inside the portion of the secondary circuit that extends inside the arm, i.e. in the outer tubular duct.

These phenomena can spoil the characteristics of injectors, possibly going as far as plugging some of them and thus leading to non-uniform carburization in the combustion chamber and to a distortion of the temperature map therein. This can result in a loss of performance in the combustion chamber and the turbine. These problems can cause burning of the high-pressure nozzle, of the high-pressure turbine, and even of certain component parts of the low-pressure turbine.

In order to avoid coking phenomena, a conventional two-circuit mechanical injector includes reinforced thermal insulation around the injector arm. Such an arm is therefore complex and expensive to fabricate, and its weight is increased by the thermal insulation elements.

### OBJECT AND BACKGROUND SUMMARY OF THE INVENTION

The invention proposes a novel design of injector, and in particular of its arm, enabling the static thermal insulation to be omitted or at least greatly reduced, by taking advantage of cooling due to the flow of fuel itself.

More precisely, the invention provides a fuel injector for a combustion chamber in a gas turbine engine, the injector being of the type comprising an injector arm having two ducts that are coaxial and that support and feed a two-jet spray head, the ducts comprising respectively a central duct and a peripheral duct of annular section surrounding said central duct, said injector head being installed in a stream of compressed air that is relatively hot, wherein said peripheral duct is suitable for being connected to a so-called “primary” fuel circuit that delivers fuel continuously, while said central duct is suitable for being connected to a so-called “secondary” fuel circuit that delivers at a rate that is essentially variable, and wherein said spray head includes an arrangement of channels enabling the fuel flowing in said central duct to be ejected as a diverging jet situated outside the jet of fuel coming from said peripheral duct.

Since fuel flows continuously in the primary circuit, the fact of making it flow around the central duct, which now carries the fuel of the secondary circuit, makes it possible to avoid coking in the central duct when the fuel therein stagnates or flows at a very low rate. The fuel of the primary circuit that is delivered at a temperature much lower than that of the air coming from the high-pressure compressor cannot suffer coking (since it flows continuously), and serves to cool the fuel of the secondary circuit whenever it is stagnating in the central duct.

It is desirable to spray the fuel coming from the primary circuit in the center of the diverging jet delivered by the injector, and to spray the fuel coming from the secondary circuit at the periphery of the spray jet, as mentioned above.

Said spray head may include a distributor connected to the ends of the two ducts that are defined in the arm. The distributor is received in a spray endpiece extending said arm, and said arrangement of channels is provided essentially within said distributor.

For example, the central duct is extended by an axial blind hole of said distributor and bores extend between said blind hole and respective grooves formed, e.g. longitudinally, in the surface of said distributor. These grooves co-operate with the inside surface of the endpiece to form outer channels that open out into an open annular cavity defined at the free end of the endpiece.

For example, a nozzle extending said distributor inside said endpiece includes external ribs that are substantially helical and in contact with the inside wall of the endpiece. Thus, the nozzle co-operates with said inside wall of the endpiece to define swirling channels arranged between the outer channels of the distributor and the annular cavity. Swirling the fuel (i.e. setting it into rotation) serves to obtain a jet that diverges.

Concerning the fuel in the primary circuit, the nozzle is hollowed out so as to co-operate with the end of said distributor to define a central cavity including a central orifice for spraying the fuel. The peripheral duct defined in the arm communicates with bores formed through the distributor and opening out into said central cavity. These bores extend at least in part at an angle relative to an axis of the distributor so as to cause the fuel in the central cavity to swirl and consequently cause the jet of sprayed fuel that is ejected to diverge.

The invention also provides an injector system for injecting fuel into a combustion chamber of a gas turbine engine, the system being of the type comprising a so-called “primary” fuel circuit that delivers fuel continuously, a so-called “secondary” fuel circuit that delivers fuel at an essentially variable rate, and an injector arm having two ducts that are coaxial and that support and feed a two-jet spray head, the ducts comprising respectively a central duct and a peripheral duct of annular section surrounding said central duct, said injector arm being installed in a stream of compressed air that is relatively hot, wherein said peripheral duct is connected to the so-called “primary” fuel circuit while said central duct is connected to the so-called “secondary” fuel circuit, and wherein said spray head includes an arrangement of channels enabling the fuel flowing in said central duct to be ejected as a diverging jet situated outside the jet of fuel coming from said peripheral duct.

### BRIEF DESCRIPTION OF THE DRAWINGS

The invention can be better understood and other advantages thereof appear more clearly in the light of the following description of an injector applying the principle thereof, given purely by way of example and described with reference to the accompanying drawings, in which:

FIG. 1 is a diagrammatic section view of the combustion chamber, showing an injector in accordance with the invention;

FIG. 2 is an exploded perspective view of the end of the injector;

FIG. 3 is a perspective view of the terminal portion of the injector, in section on III-III of FIG. 2; and

FIG. 4 is a perspective view of the same terminal portion of the injector, in section on IV-IV of FIG. 2.

### MORE DETAILED DESCRIPTION

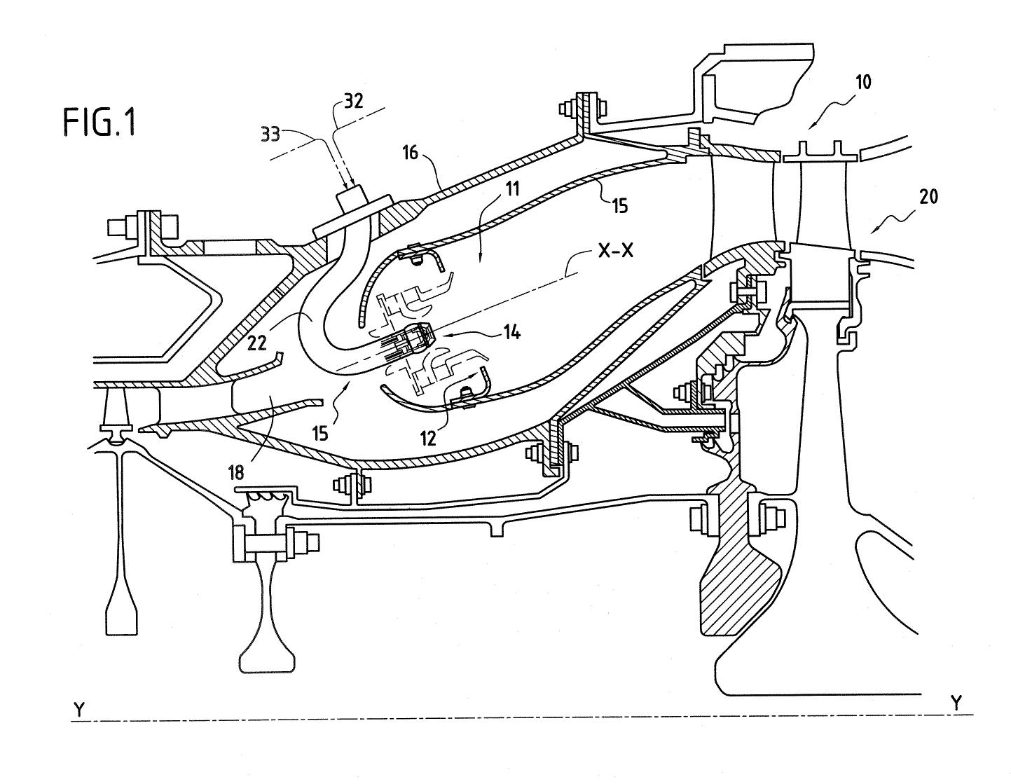

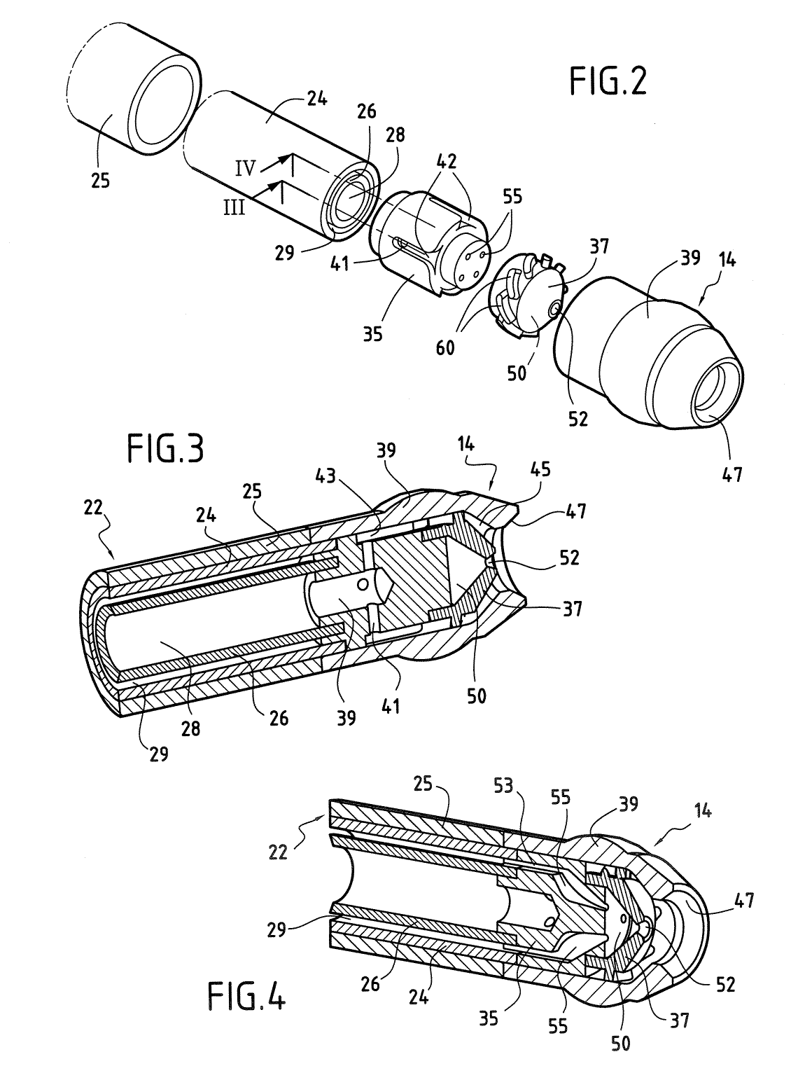

FIG. 1 is a fragmentary half-section view showing a combustion chamber 11 of an airplane turbojet 10. The combustion chamber is generally annular in shape, having an end 12 with the spray heads 14 of some number of injectors 15 being engaged therein, the injectors being carried by a casing 16 surrounding the combustion chamber. The injectors 15 are spaced apart regularly around a circumference. Relatively hot air under pressure coming from a high-pressure compressor situated upstream is injected into the casing through an annular diffuser 18. The hot air splits into two streams: one passes through the casing 16 around the combustion chamber 11; while the other engages inside the combustion chamber through orifices in the chamber end 12 so as to mix with the fuel sprayed from the spray head 14 into the combustion chamber. The fuel ignites to provide gas for driving a high-pressure turbine 20 situated downstream.

Each injector 15 comprises an injector arm 22 having two ducts that are coaxial and that support and feed the spray head 15, which is of the two-jet type. The arm 22 is bent so as to hold the spray head perpendicular to the of the chamber. The structure of the arm is very simple. It comprises an outer tube 24 surrounded by a protective cover 25 and an inner tube 26 engaged coaxially inside the outer tube so as to define two coaxial ducts: a central duct 28 defined by said inner tube; and a peripheral duct 29 of annular section surrounding the central duct and defined between the outer and inner tubes 24 and 26. As can be seen in FIG. 1, the injector arm is installed in a stream of compressed air that is relatively hot, i.e. in part the air that goes round the outside of the combustion chamber 11 and in part the air that penetrates into said combustion chamber.

Furthermore, as mentioned above, each injector 15 is connected to two fuel feed circuits serving to adapt feed conditions to different engine speeds. Outside the casing 16, the two circuits are represented by chain-dotted lines. There can be seen a so-called “primary” fuel circuit 32 or idling circuit that delivers fuel at a rate which although low is continuous, regardless of the operating conditions of the engine, and a so-called “secondary” fuel circuit 33 that delivers at a rate that is essentially variable and that can, during certain stages of operation, be very low or even almost zero.

According to an important characteristic of the invention, the peripheral duct 29 forms part of the so-called “primary” fuel circuit 32, while the central duct 28 forms part of the so-called “secondary” fuel circuit 33. Thus, for the reasons mentioned above, the fuel flowing in the peripheral duct (at a temperature much lower than that of the air flowing in the casing) does not have the time to coke because it is flowing at a sufficient rate, and it also serves to provide effective thermal protection to the fuel that is to be found in the central duct 28. The fuel flowing in the peripheral duct continuously cools the inner tube 26 and prevents heat reaching any fuel that might at certain times, be stagnating in the central duct. Consequently, coking of the fuel in the central duct is avoided.

As a result, all of the expensive and complicated insulation systems that are provided in conventional injection systems can be omitted.

In a conventional two-flow injector, it is desired that the jet of fuel coming from the secondary circuit 33 surrounds the jet of fuel coming from the primary circuit 32. To do this, in the context of the present invention, the spray head comprises an arrangement of channels enabling the fuel flowing in said central circuit 28 to be ejected as a diverging jet situated outside the jet of fuel coming from the peripheral duct 29.

As can be seen in the figures, the spray head 14 comprises at the end of the arm 22: a distributor 35, a nozzle 37 extending said distributor, and an endpiece 38 connected to the end of the arm 22 and surrounding the distributor and the nozzle.

The distributor 35 is connected to the ends of both ducts 28 and 29. It is approximately cylindrical about an axis x-x that coincides with the axis of the two diverging jets produced by the spray head 14. The above-mentioned arrangement of channels is located essentially in the distributor.

Thus, the central duct 28 is extended by an axial blind hole 39 in said distributor. Bores 41 extending perpendicularly to the blind hole (in this example four bores at 90° to one another) extend between the blind hole and respective grooves 42 formed in the surface of the distributor, longitudinally in this example. Since the endpiece 38 is fitted on the distributor, these grooves 42 co-operate with the inside surface of the endpiece to form outer channels 43 that open out into an open annular cavity 45 defined at the free end of the endpiece. The endpiece includes a conical orifice 47 that defines the outer periphery of the outlet from said open annular cavity 45. This annular cavity is defined internally by the outer surface of the nozzle 37 which is conical in this example. This extends the distributor 35 inside the endpiece and has external ribs 60 that are substantially helical and themselves in contact with the inside wall of the endpiece 38. The ribs thus co-operate with inside walls to define swirling channels that are arranged between the outer channels 43 and the annular cavity 45.

Thus, the fuel conveyed by the central duct 28 passes into the blind hole 39, then through the bores 41 and into the outer channels prior to engaging in the swirling channels. This produces a diverging jet that surrounds the jet coming from the peripheral duct.

The nozzle 37 is hollow and co-operates with the end of the distributor 35 to define a central cavity 50 that opens out axially via a central orifice 52 to spray the fuel from the primary circuit. Thus, the annular cavity 45 opens out all around the central orifice 52. The peripheral duct 29 communicates with bores 55 formed in the distributor and opening out into said central cavity 50. As shown, the bores initially extend substantially longitudinally, i.e. parallel to the axis, and then at an angle relative to the axis in order to cause the fuel to swirl in the central cavity. In this way, the jet sprayed from the central orifice 52 is caused to diverge.

The invention relates mainly to the anti-coking arrangement, i.e. essentially the structure of the arm 22. Such a structure can be used with other types of spray head designed to be fed by a primary circuit and a secondary circuit as defined above.

What is claimed is:

1. A fuel injector for a combustion chamber in a gas turbine engine, the injector being of the type comprising an injector arm having two ducts that are coaxial and that support and feed a two-jet spray head, the ducts comprising respectively a central duct and a peripheral duct of annular section surrounding said central duct, said injector head being installed in a stream of compressed air that is relatively hot, wherein said peripheral duct is suitable for being connected to a so-called “primary” fuel circuit that delivers fuel continuously, while said central duct is suitable for being connected to a so-called “secondary” fuel circuit that delivers at a rate that is essentially variable, and wherein said spray head includes an arrangement of channels enabling the fuel flowing in said central duct to be ejected as a diverging jet situated outside the jet of fuel coming from said peripheral duct.

2. A fuel injector according to claim 1, wherein said spray head includes a distributor connected to the ends of the two ducts and housed in a spray endpiece extending said arm, and wherein said arrangement of channels is formed essentially in said distributor.

3. An injector according to claim 2, wherein said central duct is extended by a blind hole in said distributor, and bores extend between said blind hole and respective grooves formed in the surface of said distributor, and wherein the grooves co-operate with the inside surface of said endpiece to form outer channels opening out into an open annular cavity defined at the free end of said endpiece.

4. An injector according to claim 3, including a nozzle extending said distributor inside said endpiece, said open cavity being defined between said nozzle and the inside wall of said endpiece, wherein said nozzle is hollowed out to co-operate with the end of said distributor to define a central cavity, and wherein said peripheral duct communicates with bores formed in said distributor and opening out into said central cavity, which includes a central orifice for ejecting fuel from said primary circuit, said annular cavity opening out all around said central orifice in order to spray fuel from said secondary circuit.

5. A fuel injector according to claim 4, wherein the bores extend at least in part at an angle relative to the axis of said distributor in order to cause the fuel in said central cavity to swirl.

6. An injector according to claim 4, wherein said nozzle has external ribs that are substantially helical and in contact with the inside wall of said endpiece in order to co-operate therewith to define swirling channels arranged between said outer channels and said annular cavity.

7. An injector according to claim 1, wherein said central duct and said peripheral duct are defined by coaxial tubes.

8. An injector system for injecting fuel into a combustion chamber of a gas turbine engine, the system being of the type comprising a so-called “primary” fuel circuit that delivers fuel continuously, a so-called “secondary” fuel circuit that delivers fuel at an essentially variable rate, and an injector arm having two ducts that are coaxial and that support and feed a two-jet spray head, the ducts comprising respectively a central duct and a peripheral duct of annular section surrounding said central duct, said injector arm being installed in a stream of compressed air that is relatively hot, wherein said peripheral duct is connected to the so-called “primary” fuel circuit while said central duct is connected to the so-called “secondary” fuel circuit, and wherein said spray head includes an arrangement of channels enabling the fuel flowing in said central duct to be ejected as a diverging jet situated outside the jet of fuel coming from said peripheral duct.

9. An injection system according to claim 8, wherein said spray head includes a distributor connected to the ends of the two ducts and housed in a spray endpiece extending said arm, and wherein said arrangement of channels is formed essentially in said distributor.

10. An injection system according to claim 9, wherein said central duct is extended by a blind hole in said distributor, and bores extend between said blind hole and respective grooves formed in the surface of said distributor, and wherein the grooves co-operate with the inside surface of said endpiece to form outer channels opening out into an open annular cavity defined at the free end of said endpiece.

11. An injection system according to claim 10, including a nozzle extending said distributor inside said endpiece, said open cavity being defined between said nozzle and the inside wall of said endpiece, wherein said nozzle is hollowed out to co-operate with the end of said distributor to define a central cavity, and wherein said peripheral duct communicates with bores formed in said distributor and opening out into said central cavity, which includes a central orifice for ejecting fuel from said primary circuit, said annular cavity opening out all around said central orifice in order to spray fuel from said secondary circuit.

12. An injection system according to claim 11, wherein the bores extend at least in part at an angle relative to the axis of said distributor in order to cause the fuel in said central cavity to swirl.

13. An injection system according to claim 11, wherein said nozzle has external ribs that are substantially helical and in contact with the inside wall of said endpiece in order to co-operate therewith to define swirling channels arranged between said outer channels and said annular cavity.

14. An injection system according to claim 8, wherein said central duct and said peripheral duct are defined by coaxial tubes.

15. A combustion chamber for a gas turbine engine, the chamber being fitted with a plurality of fuel injectors according to claim 1, spaced apart regularly around a circumference.

16. A turbo machine including a combustion chamber according to claim 15.
